(19) United States
(12) Patent Application Publication
(10) Pub. No.: US 2018/0233974 A1
(43) Pub. Date: Aug. 16, 2018

(54) Reluctance Assisted External Rotor PMSM

(71) Applicant: TM4 INC., Boucherville (CA)

(72) Inventors: Ruisheng Shi, Montreal (CA); Arbi Gharakhani, Verdun (CA)

(73) Assignee: TM4 INC., Boucherville, QC (CA)

(21) Appl. No.: 15/513,734

(22) PCT Filed: Sep. 16, 2015
(86) PCT No.: PCT/CA2015/050902

§ 371 Date: Mar. 23, 2017

Related U.S. Application Data
(60) Provisional application No. 62/054,565, filed on Sep. 24, 2014.

(51) Int. Cl. H02K 1/27; B60L 11/00; H02K 29/03; H02K 1/24; H02K 21/22; H02K 15/03; H02K 1/28

(52) U.S. Cl. CPC H02K 1/2786; B60L 11/002; H02K 29/03; H02K 2213/03; H02K 21/22; H02K 15/03; H02K 1/28; H02K 1/246

(57) ABSTRACT

A reluctance assisted external rotor permanent magnet machine provided with fewer magnets without scarifying performance is described herein. Torque ripple and cogging torque reductions are discussed.

### FIELD

The present disclosure relates to electric machines. More specifically, the present disclosure is concerned with a reluctance assisted external rotor PMSM (Permanent Magnet Synchronous Machine) having an external rotor.

### BACKGROUND

Higher gas prices, air pollution and other environmental concerns were the motivation behind the attempts to replace internal combustion engines with electric traction systems in the automotive application. Among different types of electric traction systems, machines with permanent magnet materials demonstrate a great potential due to their high torque densities and great efficiencies, which normally lead to compact sizes and higher vehicle autonomy.

In general, traction motors of electric power trains are designed to have wide torque-speed range (to be used with a single gear ratio), high torque at low speed (for better acceleration) and acceptable power at maximum speed. In addition these machines should have high efficiency values in mid speed range to increase the autonomy of the vehicle. The available space for such machines is limited due to the limitations of the application. The cost is another crucial factor. These requirements impose different constraints to be satisfied during the design process, which makes it a challenging task.

In recent years there is a trend towards direct drive machines for heavy-duty applications, which removes the need to use a gearbox in the powertrain. This helps to reduce the cost and also improves the efficiency and reliability of the whole system.

Rear-earth permanent magnets are generally used in the traction motors, mainly due to their good performances. However, the earth's resources are not infinite and rare-earth permanent magnets are getting very expensive. Accordingly, the reduction of the usage of rear-earth permanent magnets in electric motors is being studied.

### BRIEF DESCRIPTION OF THE DRAWINGS

In the appended drawings:

FIG. 1 schematically illustrates an external rotor electric machine;

FIG. 2 schematically illustrates a typical rotor configuration of an external rotor SPM machine;

FIG. 3 schematically illustrates an added lamination strip between the magnets and the rigid rotor;

FIG. 4 schematically illustrates the shifting of magnets in an external rotor machine according to a first illustrative embodiment;

FIG. 5 is a graph illustrating the cogging torque reduction due to pole shifting;

FIG. 6 is a graph illustrating the torque ripple reduction due to pole shifting;

FIG. 7 is a graph illustrating a reference SPM vs. the external rotor machine of FIG. 4; and

FIG. 8 is a front sectional elevation view of an external rotor electric machine according to a second illustrative embodiment.

### DETAILED DESCRIPTION

The reduction of the quantity of permanent magnets while decreasing the cogging torque and the torque ripples is achieved by placing different size of magnetically susceptible protrusions between magnets, thereby shifting some of the poles.

More specifically, in accordance to an illustrative embodiment, there is provided an external rotor electric machine comprising an internal stator and an external rotor coaxial to the internal stator. The external rotor includes an inner surface facing the internal stator. The external rotor includes permanent magnets arranged in a circumferential direction on the internal surface of the rotor, and magnetically susceptible protrusions respectively arranged between adjacent permanent magnets. The magnetically susceptible protrusions being so configured and sized as to position the magnets so as to reduce cogging torque and torque ripple.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

In the present specification and in the appended claims, various terminology which is directional, geometrical and/or spatial in nature such as “longitudinal”, “horizontal”, “front”, rear”, “upwardly”, “downwardly”, etc. is used. It is to be understood that such terminology is used for ease of description and in a relative sense only and is not to be taken in any way as a limitation upon the scope of the present disclosure.

The expression “connected” should be construed herein and in the appended claims broadly so as to include any cooperative or passive association between mechanical parts or components. For example, such parts may be assembled together by direct coupling, or indirectly coupled using further parts. The coupling can also be remote, using for example a magnetic field or else.

Other objects, advantages and features of the present reluctance assisted external rotor PMSM will become more apparent upon reading of the following non-restrictive description of illustrative embodiments thereof, given by way of example only with reference to the accompanying drawings.

Generally stated, illustrative embodiments are provided with magnetically susceptible protrusions provided between adjacent permanent magnets. These protrusions are not equal in size due to the magnet shifting intended to reduce the cogging torque and the torque ripples.

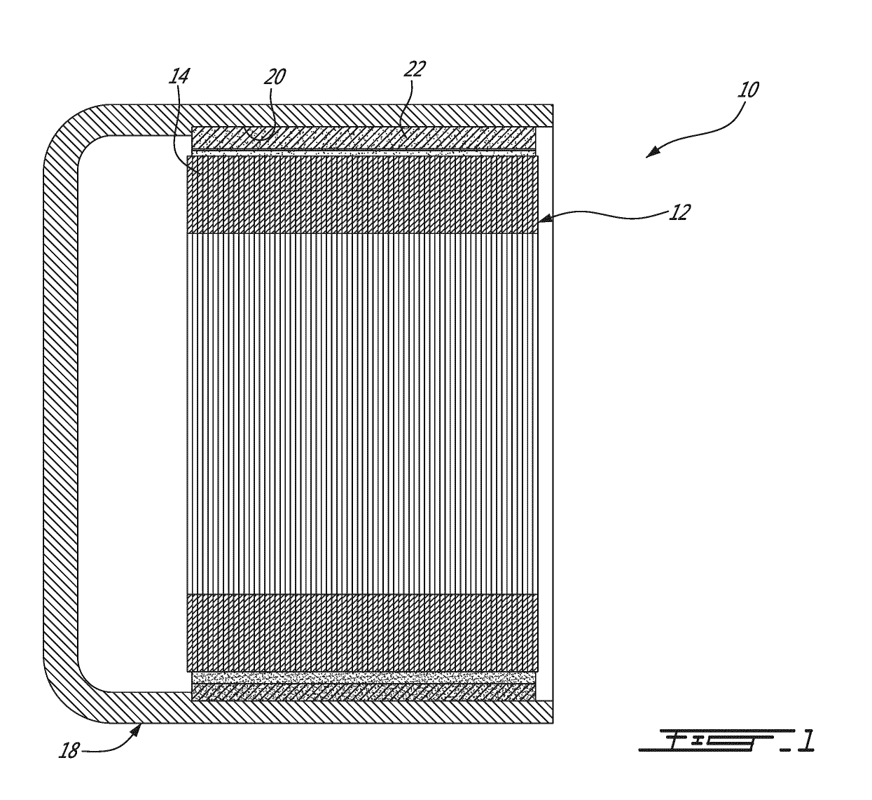

Turning now to the appended drawings, an external rotor electric machine 10 is illustrated in a side sectional view in FIG. 1. The electric machine 10 includes an internal stator 12 made of stacked laminations 14 and provided with coils (not shown) conventionally placed in outwardly facing slots. The electric machine 10 also includes an external cylindrical rotor 18 having an internal surface 20 to which are mounted permanent magnets 22.

In any electric machine, torque is resultant of the interaction between rotor and stator fluxes. In the surface mounted permanent magnet machines (PMSM), rare earth magnetic materials are the source of the rotor flux, while current is the source of the stator flux. In general it is possible to maximize the torque per current ratio by controlling the angle of the current in respect to the rotor magnet flux vector. This torque is represented by the following equation.

T=K_1φ_mlq (1)

In synchronous reluctance machines, the torque is produced due to the anisotropy of the magnetic circuit and thus the flux path. The different reluctances of D and Q axes and tendency of the rotor to align itself with the lowest reluctance path lead to production of a torque as shown in the following equation.

T=K_2(Ld−Lq)*ldlq (2)

Inset permanent magnet machines enjoy both components of the torque as shown below.

T=K_1φ_mlq+K_2(Ld−Lq)*ldlq (3)

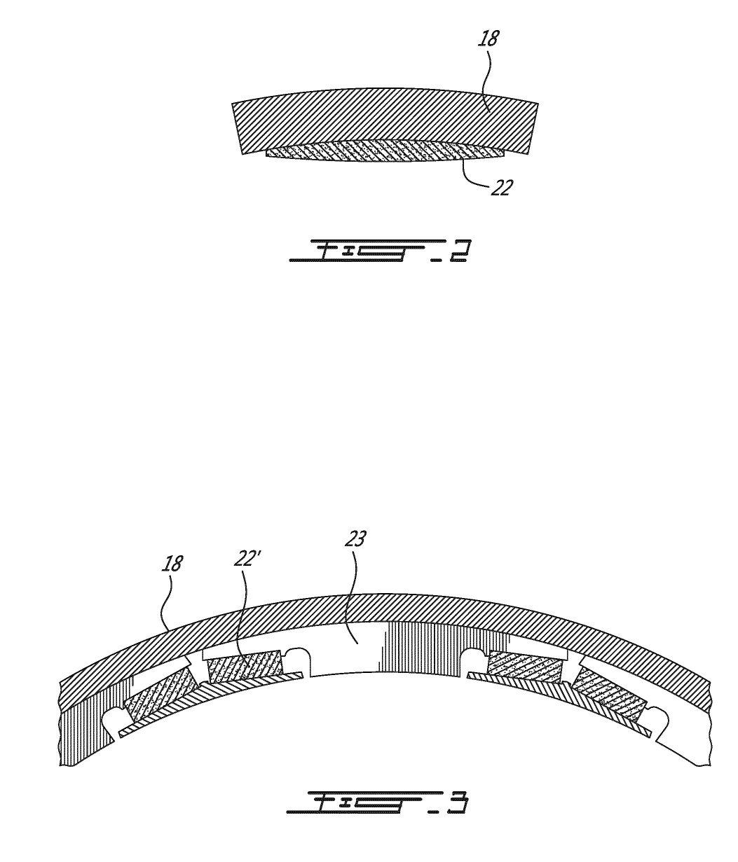

Generally, the advantage of an external rotor machine is its higher air-gap radius, which leads to a higher torque for the same magnetic force. To keep this advantage, the thickness of the rotor 18 should be kept as thin as possible. The rotor is normally made of rigid carbon steel in order tolerate the centrifugal forces and the vibration as shown in FIGS. 1 and 2.

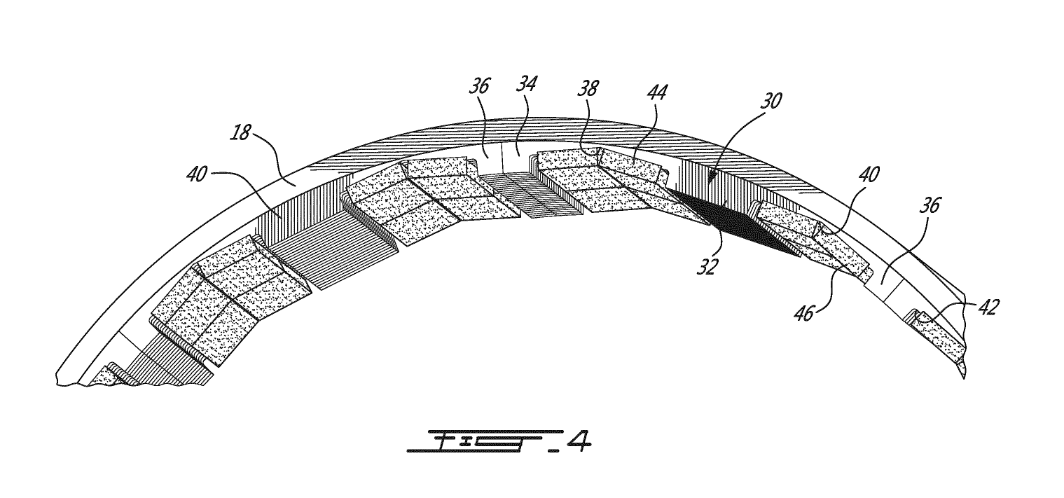

In order to create the reluctance torque, significant anisotropy (saliency) may be created in the rotor magnetic circuit, which is a demanding task due to the limited available space. In addition, this causes higher eddy current losses due to the introduced anisotropy. Thus, it is generally not practical to use carbon steel materials to achieve this goal. On the other hand, a thin rotor made of lamination cannot normally support the centrifugal forces present at high speeds. Thus, as can be seen in FIG. 3, a strip of lamination 23 is added between the magnets 22′ and the rigid carbon steel rotor 18 to achieve both the required saliency and the rigidity requirements.

The dimensions of the magnets 22′ and the rotor lamination strips 23 are generally optimized by using a stochastic optimization algorithm and by considering the design constraints typically found in automotive applications.

The final solution after optimization had considerably less magnets in comparison to the reference SPM machine with the same dimensions. Besides, performance of the proposed machine showed noticeable improvements compared to the original SPM machine. The detailed comparison is given hereinbelow.

One of the drawbacks of using reluctance torque is the associated cogging torque and the torque ripples. In general, it is interesting to keep the torque pulsations to an acceptable level. The selected approach to reduce the torque ripples is to apply pole-shifting topology.

In theory, it is possible to achieve torque harmonic cancelation by shifting the magnets circumferentially as shown in FIG. 4.

In many topologies, the dominant component of the torque harmonic is dependent to the number of slots per pole per phase (SPP). As an instance a three phase machine with SPP=1 has six slots per pole pairs which leads to the 6th harmonic of the torque. In case of a machine with SPP=2, the dominant harmonic is the 12th. To cancel the 6th harmonics, the magnets may be shifted by 30 electrical degrees. While to cancel the 12th harmonics, 15 electrical degrees shifting is generally sufficient.

The pole shifting approach illustrated in FIG. 4 can simplify the manufacturing process. However, it is physically limited by the geometry of the machine and may cause higher saturation levels in the proposed topology. In FIG. 4, individual ring segments 30 are provided with a central protrusion 32, two lateral protrusions 34, 36 and two permanent magnet receiving portions 38 and 40 located on either side of the central protrusion 32.

As can be seen from FIG. 4, the ring segments 30 includes four rounded notches 42 between the protrusions 32, 34, 36 and respective lateral magnet-receiving portions. Within a segment 30, the notches 42 together define channels between the protrusions and respective magnets to thereby prevent the magnetic field to directly go from the magnets to the protrusions. Each notch 42 defines, with the magnet-receiving portion, a small shoulder that helps positioning and maintaining in place the magnet.

Magnets 44 inserted in the magnet receiving portions 38 have their north pole facing towards the stator while magnets 46 inserted in the magnet receiving portions 40 have their south pole facing towards the stator.

The central protrusion 32 has a width that is larger than the combined with of the lateral protrusions 34 and 36. According, the spacing between adjacent magnets is not equal thereby yielding pole shifting. As mentioned hereinabove the shifting angle depends on the motor topology.

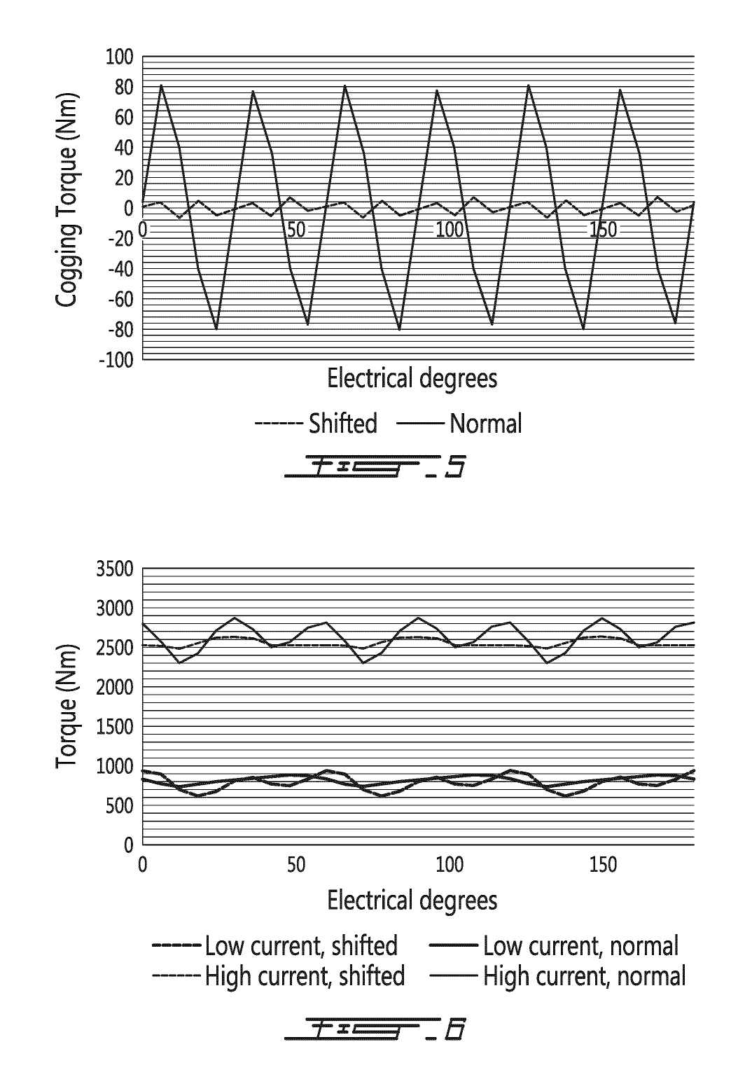

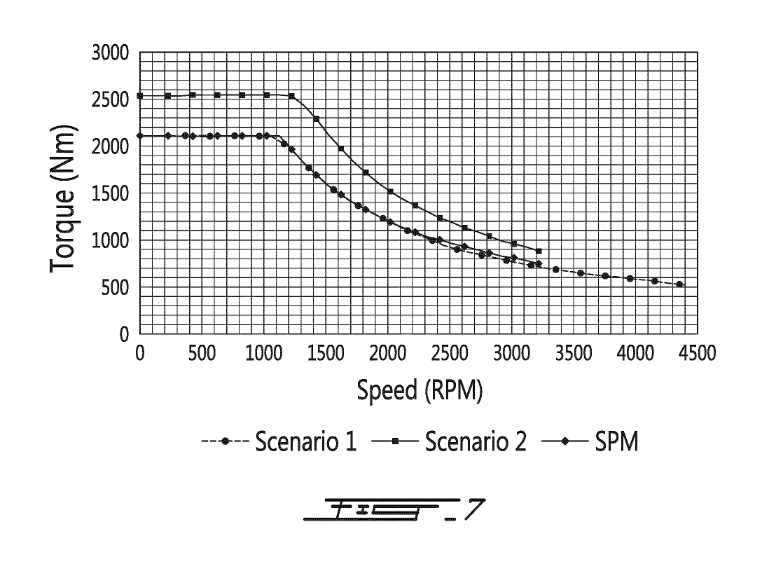

The cogging torque and torque ripple reductions due to the pole shifting method are compared in FIGS. 5 and 6 respectively, with the same machine without pole shifting. Based on the illustrated results, it can be concluded that a significant reduction can be achieved by the proposed technique.

In FIG. 6, the performance of the proposed reluctance assisted external rotor PM machine is compared with the original surface mounted PM machine. For a fair comparison the same stator assembly is used in both machines. The comparison is made for two different scenarios. In the first scenario, the maximum required torque of the new machine at low speed condition is assumed to be the same as SPM machine. In the second one, the maximum speed of the machine is kept equal to the maximum speed of the SPM machine.

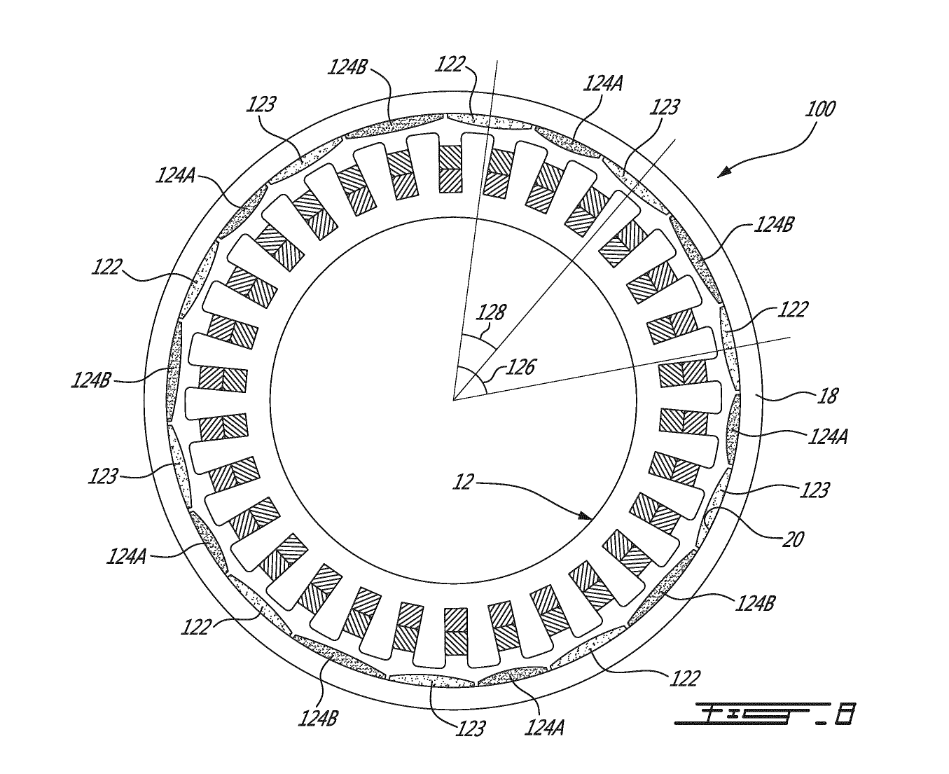

In the FIG. 7, the torque-speed characteristics of the two scenarios are compared with the reference SPM machine.

Based on FIG. 7 following conclusions can be made:

In the first scenario, 30% maximum speed increase has been achieved in comparison to the reference SPM machine with around 35% less magnet.

In the second scenario, maximum torque has been increased by 20% with around 15% less magnet. The percentage of the torque increase in scenario 2 is lower than the speed increase percentage in scenario 1. This is believed to be due to the core saturation as well as contribution of the reluctance torque.

In addition to these facts, higher D axis inductance of the reluctance assisted machine leads to easier field weakening, lower short circuit current and thus capability of tolerating short circuit current continuously. This means it is easier to design a fault tolerant machine with the proposed reluctance assisted concept. Finally higher inductance means lower eddy current losses due to the PWM switching which is a very important factor in determining the high speed continuous power of the machine.

Turning now to FIG. 8 of the appended drawings, an electric machine 100 according to a second illustrative embodiment will be described.

Generally stated, while the embodiment described hereinabove and illustrated in FIG. 4 uses stacks of laminations to embody the magnetically susceptible protrusions provided between adjacent permanent magnets, is it proposed to insert blocks of soft magnetic material (aka ferromagnetic material) such as, for example, SMC (Soft Magnetic Composite) or magnetic powders, to embody these protrusions in the electric machine 100. This addition of SMC blocks reduces the quadrature axis reluctance since it decreases the air gap thickness in the quadrature axis flux path. Accordingly, this creates a stronger supplemental reluctance torque in the electric machine, which improves performances thereof.

It has been found that by using powder metallurgy, it is possible to produces SMC blocks suitable to be positioned between adjacent permanent magnets and therefore replace some of the permanent magnets in an external rotor electric machine. Magnetic powders such as ATOMET 1 and ATOMET 3 manufactured by Rio Tinto have been found suitable to make the SMC blocks.

Permanent magnets 122 have their north pole facing the stator 12 and permanent magnets 123 have their south pole facing the stator 12.

As can be better seen from FIG. 8, which is a front elevation view of the electric machine 100, the SMC blocks 124A and 124B and the permanent magnets 122, 123 are alternatively mounted to the internal surface 20 of the rotor 18.

One skilled in the art will understand that an adhesive (not shown) may be provided between the SMC blocks 124A, 124B and the rotor 18 and between the magnets 122, 123 and the rotor 18. Alternatively, other mechanical elements (not shown) can be used to adequately mount the SMC blocks and the magnets to the rotor 18.

In the electric machine 100, the permanent magnets 122 and 123 are not equally spaced and as a consequence, two sizes of SMC blocks 124A and 124B are present.

Indeed, as mentioned hereinabove, to decrease the cogging torque and the torque ripple in the machine 100, the permanent magnets 122, 123 are not equally spaced on the internal surface 20 of the rotor 18. As can be seen from this figure, the 360 degrees electric angle 126 separating two consecutive magnets 122 having their north pole facing the stator 12 is not conventionally divided in two by the magnet 123 positioned therebetween.

Indeed, the angle shifting of poles depends on the design requirements. As mentioned hereinabove, 30 electric degree shifting is chosen to reduce the 6^{th} torque harmonic while 15 degree is chosen to reduce the 12^{th} torque harmonic, and so on.

In the case shown in FIG. 8, 15 degree shifting is applied in this configuration since the cogging and torque ripple reduction are required in the 12^{th} harmonic. Indeed, an electric angle 128 is 165 degrees.

The SMC blocks 124A and 124B are therefore not identical in size to keep a substantially equal distance between adjacent blocks and magnets.

As will be understood by one skilled in the art, the electric machines 10 and 100 illustrated herein and described hereinabove are schematic and lack many required elements for their operation. Indeed, only the elements relating to the comprehension of the external rotor electric machine have been shown and discussed.

One skilled in the art will understand that the reduction of the quantity of permanent magnet material used can be realized by changing the size of the permanent magnets and of the SMC blocks.

It is to be understood that the reluctance assisted external rotor PMSM is not limited in its application to the details of construction and parts illustrated in the accompanying drawings and described hereinabove. The reluctance assisted external rotor PMSM is capable of other embodiments and of being practiced in various ways. It is also to be understood that the phraseology or terminology used herein is for the purpose of description and not limitation. Hence, although the reluctance assisted external rotor PMSM has been described hereinabove by way of illustrative embodiments thereof, it can be modified, without departing from the spirit, scope and nature thereof.

What is claimed is:

1. An external rotor electric machine comprising:
an internal stator; and
an external rotor coaxial to the internal stator; the external rotor including an inner surface facing the internal stator; the external rotor including permanent magnets arranged in a circumferential direction on the internal surface of the rotor, and magnetically susceptible protrusions respectively arranged between adjacent permanent magnets; the magnetically susceptible protrusions being so configured and sized as to position the magnets so as to reduce cogging torque and torque ripple.

2. The external rotor electric machine as recited in claim 1, wherein the protrusions consist of stacks of laminations made of soft magnetic material.

3. The external rotor electric machine as recited in claim 2, wherein the stacks of laminations are individual ring segments including a central protrusion, two lateral protrusions and two permanent magnet receiving portions located on either side of the central protrusion.

4. The external rotor electric machine as recited in claim 3, wherein the individual ring segments are so configured and sized as to be applied to the internal surface of the rotor.

5. The external rotor electric machine as recited in claim 4, wherein the sizes of the central and lateral protrusions are such that adjacent magnets are angularly shifted.

6. The external rotor electric machine as recited in claim 5, wherein adjacent magnets are angularly shifted of an angle of 15 degrees.

7. The external rotor electric machine as recited in claim 5, wherein adjacent magnets are angularly shifted of an angle of 30 degrees.

8. The external rotor electric machine as recited in claim 1, wherein the protrusions consist of blocks of SMC (Soft Magnetic Composite).

9. The external rotor electric machine as recited in claim 8, wherein the SMC blocks are so configured and sized as to be applied to the internal surface of the rotor.

10. The external rotor electric machine as recited in claim 9, wherein the sizes of SMC blocks are such that adjacent magnets are angularly shifted.

11. The external rotor electric machine as recited in claim 10, wherein adjacent magnets are angularly shifted of an angle of 15 degrees.

12. The external rotor electric machine as recited in claim 10, wherein adjacent magnets are angularly shifted of an angle of 30 degrees.
